(19) United States
(12) Patent Application Publication
(10) Pub. No.: US 2002/0018853 A1
(43) Pub. Date: Feb. 14, 2002

(54) Sulfur sorbent composition and sorption process

(76) Inventor: Gyanesh P. Khare, Kingwood, TX (US)

Correspondence Address: RICHMOND, HITCHCOCK,, FISH & DOLLAR, P.O. Box 2443, Bartlesville, OK, 74005, US

(21) Appl. No.: 09/860,674

(22) Filed: May 18, 2001

Related U.S. Application Data
(63) Continuation-in-part of application No. 09/343,382, filed on Jun. 30, 1999, now abandoned.

(30) Foreign Application Priority Data
Jun. 29, 2000 (US) PCT/US00/17908

(51) Int. Cl. B01D 53/02; B01J 20/10; B05D 1/02; B05D 3/02

(52) U.S. Cl. 427/387; 502/401; 502/405; 502/407; 502/411; 95/136; 427/421

(57) ABSTRACT

A method for the manufacture of a sorbent composition having an attrition-resistant coating suitable for use in the removal of hydrogen sulfide from sulfur-containing fluid streams. Also disclosed is a process for removing hydrogen sulfide from sulfur-containing fluid streams and a sorbent composition suitable for use in such process.

This application is a continuation-in-part of application Ser. No. 09/343,382, filed Jun. 30, 1999, now allowed.

### BACKGROUND OF THE INVENTION

This invention relates to a method for the manufacture of a sulfur sorbent suitable for use in the removal of hydrogen sulfide from sulfur-containing fluid streams. In another aspect, this invention relates to a process for removing hydrogen sulfide from sulfur-containing fluid streams. A further aspect of this invention relates to a composition suitable for use in such process.

The removal of sulfur from sulfur-containing fluid streams can be desirable or necessary for a variety of reasons. If a sulfur-containing fluid stream is to be released as a waste stream, removal of sulfur from the sulfur-containing fluid stream is often necessary to meet certain environmental regulations. Further, if the sulfur-containing fluid stream is to be burned as a fuel, removal of sulfur from the sulfur-containing fluid stream can be necessary to prevent environmental pollution. If a sulfur-containing fluid stream is to be used in a catalytic process, removal of such sulfur is often necessary to prevent catalyst poisoning or to satisfy other process requirements.

Traditionally, sulfur sorbents used in processes for the removal of sulfur from sulfur-containing fluid streams have been agglomerates utilized in fixed bed applications. Because of the various process advantages of fluidized beds, sulfur-containing fluid streams are sometimes used in fluidized bed reactors. Fluidized bed reactors have advantages over fixed bed reactors such as better heat transfer and better pressure drop. Fluidized bed reactors generally use reactants that are particulates. The size of these particulates is generally in the range of about 1 micrometer to about 10 millimeters. However, the reactants used generally do not have sufficient attrition resistance for all applications. Consequently, finding a sorbent with sufficient attrition resistance that removes sulfur from these sulfur-containing fluid streams and that can be used in fluidized, transport, moving, or fixed bed reactors is desirable and would be of significant contribution to the art and to the economy.

### SUMMARY OF THE INVENTION

It is thus an object of the present invention to provide a process to produce a sorbent composition that has improved attrition resistance and that can be used in fluidized, transport, moving, or fixed bed reactors.

Another object of the present invention is to provide a sorbent composition with an attrition-resistant coating that can be used in fluidized, transport, moving, or fixed bed reactors. Yet another object of the present invention is to provide a process for removing hydrogen sulfide from a sulfur-containing fluid stream utilizing a sorbent composition with an attrition-resistant coating.

In accordance with one aspect of the present invention, there is provided a sorbent composition having a mean particle size generally in the range of from about 1 micrometer to about 10 millimeters wherein such sorbent composition has an attrition-resistant coating so that such sorbent composition has improved attrition resistance when compared to a sorbent composition that does not have such attrition-resistant coating.

In accordance with another aspect of the invention, there is provided a process to produce a sorbent composition having a mean particle size generally in the range of from about 1 micrometer to about 10 millimeters wherein such sorbent composition has an attrition-resistant coating. Such process comprises mixing appropriate proportions of a zinc component, an alumina component, and a silica component to form a mixture. The mixture is impregnated with an aqueous solution of a metal-containing compound to form an impregnated mixture. The impregnated mixture is agglomerated followed by granulation to provide an agglomerated base sorbent material. The agglomerated base sorbent material is then coated with an attrition-resistant coating to produce a sorbent composition with enhanced attrition resistance, compared to a sorbent composition that does not have such coating, that is suitable for use as a fluidizable material. The agglomerated base sorbent material may be contacted with a metal-containing compound before or after being coated with an attrition-resistant coating.

In accordance with yet another aspect of the invention, there is provided a process to produce a sorbent composition having a mean particle size generally in the range of from about 1 micrometer to about 1000 micrometers wherein such sorbent composition has an attrition-resistant coating. Such process comprises: (a) contacting a zinc component, an alumina component, a silica component, and a dispersant component, to form a mixture; and (b) spray drying such mixture to form a spray-dried base sorbent material which is then coated with an attrition-resistant coating to produce a sorbent composition with enhanced attrition resistance, compared to a sorbent composition that does not have such coating, that is suitable for use as a fluidizable material. The spray-dried base sorbent material may be contacted with a metal-containing compound before or after being coated with an attrition-resistant coating.

Yet another aspect of the invention is a process for removing hydrogen sulfide from a sulfur-containing fluid stream containing hydrogen sulfide by contacting the sulfur-containing fluid stream with a sorbent composition having enhanced attrition resistance, and recovering a stream having a concentration of hydrogen sulfide lower than that of the sulfur-containing fluid stream. The sorbent composition has a mean particle size generally in the range of from about 1 micrometer to about 10 millimeters wherein such sorbent composition has an attrition-resistant coating.

Other objects and advantages of the invention will become more apparent from the detailed description of the invention and the appended claims.

### DETAILED DESCRIPTION OF THE INVENTION

Generally, the inventive process(es) can be used to apply an attrition-resistant coating to a base sorbent material. The term “base sorbent material” refers to a sorbent material which can be coated with the inventive attrition-resistant coating using the inventive process(es) described herein to thereby provide a sorbent composition with an attrition-resistant coating having improved attrition resistance when compared to a base sorbent material or a sorbent that does not have such inventive attrition-resistant coating. The term “sorbent composition” refers to a sorbent composition that has been coated with an inventive attrition-resistant coating using the inventive process(es) described herein to thereby provide a sorbent composition having a mean particle size generally in the range of from about 1 micrometer to about 10 millimeters and having an enhanced attrition resistance when compared to a sorbent which does not have such inventive attrition-resistant coating.

While the base sorbent material can be prepared by any process which provides a base sorbent material suitable for use with the inventive process(es) described herein, it is preferred that the base sorbent material be prepared by an agglomeration technique or a spray-drying technique. Thus, the term “agglomerated base sorbent material” refers to a base sorbent material prepared using an agglomeration technique. The term “spray-dried base sorbent material” refers to a base sorbent material prepared using a spray-drying technique. A preferred method of preparing an agglomerated base sorbent material is described in U.S. Pat. No. 5,439,867 the disclosure of which is incorporated herein by reference. A preferred method of preparing a spray-dried base sorbent material is described in U.S. Pat. No. 5,710,091 the disclosure of which is incorporated herein by reference.

Generally, the base sorbent material contains a zinc component such as zinc oxide or in the form of one or more zinc compounds that are convertible to zinc oxide under the conditions of preparation described herein. Examples of such compounds include, but are not limited to, zinc oxide, zinc sulfide, zinc sulfate, zinc hydroxide, zinc carbonate, zinc acetate, zinc nitrate, zinc chloride, zinc bromide, zinc iodide, zinc oxychloride, zinc stearate, and the like and combinations thereof. Mixtures of such compounds can also be used. Generally, the amount of a zinc component in the base sorbent material is in the range of from about 5 weight percent based on the total weight of the base sorbent material to about 75 weight percent. Preferably, the amount of a zinc component in the base sorbent material is in the range of from about 15 weight percent to about 60 weight percent and, more preferably, the amount of a zinc component in the base sorbent material is in the range of from 25 weight percent to 45 weight percent.

In preparing the agglomerated base sorbent material to be coated with the inventive attrition-resistant coating, the starting alumina component of the agglomerated base sorbent material can be any suitable alumina or aluminosilicate including colloidal alumina solutions and, generally, those alumina compounds produced by the dehydration of alumina hydrates. A preferred alumina is boehmite alumina. The alumina can also contain minor amounts of other ingredients, such as, for example, 1 weight percent silica to 10 weight percent silica, which do not adversely affect the quality of the sorbent composition, but it is generally desirable to have an essentially pure alumina as a starting material for preparing the agglomerated base sorbent material. The starting alumina can be made in any manner well known in the art, examples of which are described at length in Kirk-Othmer Encyclopedia of Chemical Technology, 3rd Edition, Vol. 2, pp. 218-240. As an example, a suitable commercially available starting alumina for use in preparing the agglomerated base sorbent material is manufactured by Vista Corporation, designated as CATAPAL and DISPAL aluminas.

In preparing the spray-dried base sorbent material to be coated with the inventive attrition-resistant coating, the alumina component used in the process(es) of preparation which include spray drying, include, but are not limited to, hydrated alumina, flame-hydrolyzed alumina, and the like and combinations thereof.

The amount of an alumina component used, regardless of the process used to prepare the base sorbent material, is generally in the range of from about 1 weight percent based on the total weight of the base sorbent material to about 50 weight percent. Preferably, the amount of an alumina component used is in the range of from about 5 weight percent to about 30 weight percent and, more preferably, the amount of an alumina component is in the range of from 10 weight percent to 20 weight percent.

In preparing the base sorbent material to be coated with the inventive attrition-resistant coating, regardless of the process used to prepare such base sorbent material, it is preferred that a silica component be present in the base sorbent material. The silica component used may be either in the form of silica, or in the form of one or more silicon compounds that are convertible to silica under the conditions of preparation described herein. Any suitable type of silica may be used in the base sorbent material employed in the process of the present invention. Examples of suitable types of silica include diatomite, silicalite, silica colloid, flame-hydrolyzed silica, hydrolyzed silica, and precipitated silica, and the like and combinations thereof. Examples of silicon compounds that are convertible to silica under the conditions of preparation described herein include silicic acid, sodium silicate, ammonium silicate, organic silcates, and the like. Preferably, the silica is in the form of diatomite.

The amount of a silica component used, regardless of the method of preparing the base sorbent material, is generally in the range of from about 5 weight percent based on the total weight of the base sorbent material to about 85 weight percent. Preferably, the amount of a silica component used is in the range of from about 10 weight percent to about 70 weight percent and, more preferably, in the range of from 20 weight percent to 60 weight percent.

In preparing the agglomerated base sorbent material to be coated with the inventive attrition-resistant coating, any suitable means for mixing the sorbent components can be used to achieve the desired dispersion of the materials. Many of the possible mixing means suitable for use in the inventive process(es) are described in detail in Perry's Chemical Engineers' Handbook, Sixth Edition, published by McGraw-Hill, Inc., at pages 19-14 through 19-24, which pages are incorporated herein by reference. Thus, suitable mixing means can include, but are not limited to, such devices as tumblers, stationary shells or troughs, muller mixers, which are either batch type or continuous type, impact mixers, and the like. It is preferred to use a muller mixer in the mixing of the zinc, alumina and silica components. Preferably, the agglomerated base sorbent material is promoted with a precursor of nickel oxide such as nickel nitrate.

Any means suitable for forming an agglomerate of the impregnated mixture can be utilized. The agglomerate can be formed by such methods as molding, tableting, pressing, pelletizing, extruding, tumbling and densifying. The preferred method of agglomeration is by densification.

Various approaches can be used in performing the preferred densification of the mixture. In the preferred of these methods, the powdered components are placed in the bowl of a kneader or muller mixer of which the bowl and blades are rotated while simultaneously adding either water or, preferably, an aqueous acid solution, to the mixture to form a paste. The aqueous acid solution can have an acid concentration of from about 0.1 to about 30 weight percent acid selected from the group consisting of HCl, H₂SO₄, HNO₃ and CH₃COOH. The amount of water or aqueous acid solution added to the mixture during densification can generally be in the range of from about 20 weight percent to about 60 weight percent of the resultant slurry or paste, but, preferably, it can be in the range of from 30 weight percent to 50 weight percent.

The paste produced by the densification method can be dried under a drying condition. Such drying condition includes a temperature generally in the range of from about 130° F. to about 550° F., preferably in the range of from about 140° F. to about 450° F. and, more preferably, in the range of from 150° F. to 350° F. Such drying condition includes a time period for conducting the drying generally in the range of from about 0.5 hour to about 8 hours, preferably in the range of from about 1 hour to about 6 hours and, more preferably, in the range of from 1.5 hours to 4 hours. Such drying condition includes a pressure generally in the range of from about atmospheric (i.e., about 14.7 pounds per square inch absolute) to about 100 pounds per square inch absolute (psia), preferably about atmospheric.

The thus-dried paste can also be calcined under a calcining condition, preferably in an oxidizing atmosphere such as in the presence of oxygen or air. Such calcining condition includes a temperature suitable for achieving the desired degree of calcination, for example, generally in the range of from about 300° F. to about 1650° F., preferably, in the range of from about 350° F. to about 1600° F., and, more preferably, in the range of from 400° F. to 1500° F. Such calcining condition includes a period of time suitable for achieving the desired degree of calcination, for example, generally in the range of from about 0.5 hour to about 6 hours, preferably, in the range of from about 1 hour to about 5 hours and, more preferably, in the range of from 1.5 hours to 4 hours to produce a material for granulation. Such calcining condition includes a pressure generally in the range of from about 7 pounds per square inch absolute (psia) to about 750 psia, preferably in the range of from about 7 psia to about 450 psia, and, more preferably, in the range of from 7 psia to 150 psia.

The next step in preparing the agglomerated base sorbent material includes grinding, crushing or granulating of the agglomerate so as to produce a granulated material having the critical physical properties necessary for a fluidizable material. Any suitable means for granulating the agglomerate into particles having physical properties which provide for a fluidizable material can be used. Many of the granulating means or grinding means or crushing means suitable for use in the inventive process are described in detail in the aforementioned Perry's Chemical Engineers' Handbook, Sixth Edition published by McGraw-Hill, Inc., at pages 8-20 through 8-48, which pages are incorporated herein by reference. Thus, suitable grinding, granulating or crushing means can include such devices as crushers, mills, shredders, and cutters. The preferred apparatus for the size reduction of the agglomerate into fluidizable particles includes mills.

One aspect of the inventive process(es) or method(s) described herein is that the base sorbent material be a particulate material having a mean particle size generally in the range of from about 1 micrometer to about 10 millimeters. Preferably, the particles can have a mean particle size in the range of from about 10 micrometers to about 1000 micrometers. More preferably, the particles can have a mean particle size in the range of from about 20 micrometers to about 500 micrometers and, most preferably, the mean particle size can be in the range of from 30 micrometers to 400 micrometers.

Generally, the agglomerated base sorbent material has a mean particle size in the range of from about 1 micrometer to about 10 millimeters, preferably in the range of from about 10 micrometers to about 1000 micrometers, more preferably in the range from about 20 micrometers to about 500 micrometers and, most preferably, in the range of from 30 micrometers to 400 micrometers.

Generally, the spray-dried base sorbent material has a mean particle size in the range of from about 10 micrometers to about 1000 micrometers, preferably in the range of from about 20 micrometers to about 500 micrometers and, more preferably, in the range of from 30 micrometers to 400 micrometers.

The term “mean particle size” refers to the size of the particulate material as determined by using a RO-TAP Testing Sieve Shaker, manufactured by W.S. Tyler Inc., of Mentor, Ohio, or other comparable sieves. The material to be measured is placed in the top of a nest of standard eight inch diameter stainless steel frame sieves with a pan on the bottom. The material undergoes sifting for a period of about 10 minutes; thereafter, the material retained on each sieve is weighed. The percent retained on each sieve is calculated by dividing the weight of the material retained on a particular sieve by the weight of the original sample. This information is used to compute the mean particle size.

Another preparation of the agglomerated base sorbent material includes a drying step whereby the agglomerated base sorbent material is dried under a drying condition prior to granulating the thus-dried agglomerate. Such drying condition includes a temperature generally in the range of from about 100° F. to about 650° F. Preferably, the agglomerate can be dried prior to granulation at a temperature in the range of from about 150° F. to about 600° F. and, more preferably, in the range of from 200° F. to 550° F. Such drying condition includes a time period for conducting such drying generally in the range of from about 0.5 hour to about 8 hours, preferably in the range of from about 1 hour to about 6 hours and, more preferably, in the range of from 1.5 hours to 4 hours. Such drying condition includes a pressure generally in the range of from about atmospheric (i.e., about 14.7 pounds per square inch absolute) to about 100 pounds per square inch absolute (psia), preferably about atmospheric.

The dried agglomerate can also be calcined under a calcining condition, preferably in an oxidizing atmosphere such as in the presence of oxygen or air. Such calcining condition includes a temperature suitable for achieving the desired degree of calcination, for example, generally in the range of from about 700° F. to about 1600° F., preferably, in the range of from about 800° F. to about 1500° F., and, more preferably, in the range of from 900° F. to 1400° F. Such calcining condition includes a period of time suitable for achieving the desired degree of calcination, for example, generally in the range of from about 0.5 hour to about 6 hours, preferably, in the range of from about 1 hour to about 5 hours and, more preferably, in the range of from 1.5 hours to 4 hours to produce a material for granulation. Such calcining condition also includes a pressure generally in the range of from about 7 pounds per square inch absolute (psia) to about 750 psia, preferably in the range of from about 7 psia to about 450 psia, and, more preferably, in the range of from 7 psia to 150 psia.

Silica will generally be present in the sorbent composition, regardless of the method of preparing the base sorbent material, in an amount in the range of from about 5 weight percent based on the total weight of the sorbent composition to about 85 weight percent, preferably in the range of from about 10 weight percent to about 70 weight percent and, more preferably, in the range of from 20 weight percent to 60 weight percent.

In preparing the spray-dried base sorbent material to be coated with the inventive attrition-resistant coating, a dispersant component is utilized and can be any suitable compound that helps to promote the spray drying ability of the mixture. In particular, these components are useful in preventing deposition, precipitation, settling, agglomerating, adhering, and caking of solid particles in a fluid medium. Suitable dispersants include, but are not limited to, condensed phosphates, sulfonated polymers, and the like and combinations thereof. The term condensed phosphates refers to any dehydrated phosphate where the H₂O:P₂O₅ is less than about 3:1. Specific examples of suitable dispersants include, but are not limited to, sodium pyrophosphate, sodium metaphosphate, sulfonated styrene maleic anhydride polymer, and the like and combinations thereof. The amount of a dispersant component used is generally in the range of from about 0.01 weight percent based on the total weight of the components to about 10 weight percent. Preferably, the amount of a dispersant component used is generally in the range of from about 0.1 weight percent to about 8 weight percent and, more preferably, the amount of a dispersant component used is in the range of from 1 weight percent to 3 weight percent.

Preferably, the base sorbent material, regardless of the method of preparing such base sorbent material, additionally comprises a binder component. The binder component can be any suitable compound that has cement-like properties, or clay-like properties, which can help to bind the particulate composition together. Suitable examples of such binder components include, but are not limited to, colloidal silica, sodium silicate, cements such as, for example, gypsum plaster, common lime, hydraulic lime, natural cements, portland cements, and high alumina cements, and clays, such as, for example, attapulgite, bentonite, halloysite, hectorite, kaolinite, montmorillonite, pyrophylite, sepiolite, talc, vermiculite, and the like and combinations thereof. A particularly preferred binder component is calcium aluminate. The amount of binder component in the base sorbent material is generally in the range of from about 0.1 weight percent based on the total weight of the base sorbent material to about 50 weight percent. Preferably, the amount of binder component in the base sorbent material is in the range of from about 1 weight percent to about 40 weight percent and, more preferably, in the range of about 5 weight percent to about 30 weight percent.

In preparing the spray-dried base sorbent material to be coated with the inventive attrition-resistant coating, an acid component can be used. In general, the acid component can be an organic acid or a mineral acid. If the acid component is an organic acid, it is preferred if it is a carboxylic acid. If the acid component is a mineral acid it is preferred if it is a nitric acid, a phosphoric acid, or a sulfuric acid. Mixtures of these acids can also be used. Generally, the acid is used with water to form a dilute aqueous acid solution. The amount of acid in the acid component is generally in the range of from about 0.01 volume percent based on the total volume of the acid component to about 20 volume percent. Preferably, the amount of acid is in the range of from about 0.1 volume percent to about 15 volume percent and, more preferably, the amount of acid is in the range of from 1 volume percent to 10 volume percent. In general, the amount of acid component to be used is based on the amount of the dry components. That is, the ratio of all the dry components (in grams) to the acid component (in milliliters) should be less than about 1.75:1. However, it is preferred if this ratio is less than about 1.25:1 and it is more preferred if it is less than about 0.75:1. These ratios will help to form a mixture that is a liquid solution, a slurry, or a paste that is capable of being dispersed in a fluid-like spray.

In preparing the spray-dried base sorbent material to be coated with the inventive attrition-resistant coating, a zinc component, an alumina component, a silica component, and a dispersant component can be contacted together in any manner known in the art that will form a mixture that is a liquid solution, a slurry, or a paste that is capable of being dispersed in a fluid-like spray. When a zinc component, an alumina component, a silica component, and a dispersant component are solids then they should be contacted in a liquid medium to form a mixture that is a liquid solution, a slurry, or a paste that is capable of being dispersed in a fluid-like spray. Suitable means for contacting these components are known in the art such as, for example, tumblers, stationary shells, troughs, muller mixers, impact mixers, and the like. If desired, a binder component can be contacted with the other components.

Generally, these components, after contacting to form a mixture, are contacted with an acid component as described hereinabove. However, the dry components and the acid component(s) can be contacted together simultaneously or separately.

After the components are contacted together to form a mixture, they are subjected to spray drying to form a spray-dried base sorbent material having particles that have a mean particle size in the ranges as disclosed hereinabove. Spray drying is known in the art and is discussed in Perry's Chemical Engineers' Handbook, Sixth Edition, published by McGraw-Hill, Inc., at pages 20-54 through 20-58, which pages are incorporated herein by reference. Additional information can be obtained from the Handbook of Industrial Drying, published by Marcel Dekker. Inc. at pages 243 through 293.

The spray-dried base sorbent material can then be calcined, preferably in an oxidizing atmosphere such as in the presence of oxygen or air, under a calcining condition to form a calcined, spray-dried base sorbent material. The calcination can be conducted under any suitable condition that removes residual water and oxidizes any combustibles. Usually, the spray-dried base sorbent material is calcined in an oxygen-containing atmosphere. Such calcining condition includes a temperature suitable for achieving the desired degree of calcination, for example, generally in the range of from about 700° F. to about 1600° F., preferably, in the range of from about 800° F. to about 1500° F., and, more preferably, in the range of from 900° F. to 1400° F. Such calcining condition includes a period of time suitable for achieving the desired degree of calcination, for example, generally in the range of from about 0.5 hour to about 6 hours, preferably, in the range of from about 1 hour to about 5 hours and, more preferably, in the range of from 1.5 hours to 4 hours. Such caining condition includes a pressure generally in the range of from about 7 pounds per square inch absolute (psia) to about 750 psia, preferably in the range of from about 7 psia to about 450 psia, and, more preferably, in the range of from 7 psia to 150 psia.

A metal promoter component can be added to the base sorbent material, regardless of the method of preparing such base sorbent material, to be coated with the inventive attrition-resistant coating using the inventive process(es) described herein. The metal promoter component(s) can improve the physical and chemical properties of the sorbent composition. For example, the metal promoter component(s) can increase the ability of the sorbent composition to hydrogenate various compounds such as sulfur oxide species. Examples of suitable metal promoter components include, but are not limited to, oxides of the metals of Group VIII of the Periodic Table of the Elements, molybdenum oxide, tungsten oxide, iron oxide, cobalt oxide, nickel oxide, ruthenium oxide, rhodium oxide, palladium oxide, osmium oxide, iridium oxide, platinum oxide, copper oxide, chromium oxide, titanium oxide, zirconium oxide, tin oxide, manganese oxide, and the like and combinations thereof. The amount of metal promoter component in the base sorbent material is generally in the range of from about 0.01 weight percent based on the total weight of the base sorbent material to about 60 weight percent. However, it is more preferable if the amount is in the range of from about 0.1 weight percent to about 50 weight percent, and, more preferably, the amount is in the range of from 1 weight percent to 40 weight percent.

A metal promoter component can be added to the base sorbent material in the form of elemental metal, metal oxide, and/or metal-containing compounds that are convertible to metal oxides under the calcining conditions described herein. Some examples of such metal-containing compounds include metal acetates, metal carbonates, metal nitrates, metal sulfates, metal thiocyanates and the like and combinations thereof. Preferably, the metal of such metal promoter component is nickel. In a preferred embodiment of the present invention, the sorbent composition is promoted with a precursor of nickel oxide such as nickel nitrate.

The metal promoter component, such as elemental metal, metal oxide, and/or metal-containing compounds, preferably nickel nitrate, can be added to the base sorbent material by any method(s) or means known in the art. One such method is the impregnation of the base sorbent material with a liquid medium, either aqueous or organic, that contains the metal promoter component. After the metal promoter component(s) has been added to the base sorbent material, the base sorbent material is dried and calcined as described hereinabove.

In preparing the agglomerated base sorbent material, the mixture of a zinc component, an alumina component, and a silica component can be impregnated with an aqueous solution of a metal promoter component prior to agglomeration followed by granulation. The method can also comprise the impregnation of an agglomerate of the mixture of a zinc component, an alumina component, and a silica component, with an aqueous solution of a metal promoter component followed by granulation. Another alternative comprises the impregnation of the granulate, formed by the granulation of an agglomerate of a mixture of a zinc component, an alumina component, and a silica component, with an aqueous solution of a metal promoter component. If the metal promoter component is nickel oxide or a precursor of nickel oxide, it is preferred to perform the impregnation step after the granulation step.

In preparing the agglomerated base sorbent material, the impregnation solution is any aqueous solution and amount of such solution which suitably provides for the impregnation of the mixture of a zinc component, an alumina component, and a silica component to give an amount of metal promoter component in the sorbent composition generally in the range of from about 0.01 weight percent based on the total weight of the sorbent composition to about 60 weight percent. However, it is more preferable if the amount is in the range of from about 0.1 weight percent to about 50 weight percent, and, more preferably, the amount is in the range of from 1 weight percent to 40 weight percent.

The aqueous solution can include a metal promoter component that is soluble in an aqueous medium, preferably water. The concentration of the metal promoter component in the aqueous solution can be in the range of from about 0.1 gram of metal promoter component per gram of aqueous solution to about 5 grams of metal promoter component per gram of aqueous solution. Preferably, the weight ratio of metal promoter component to the aqueous medium of such aqueous solution can be in the range of from about 1:1 to about 4:1 but, more preferably, it is in the range of from 1.5:1 to 3:1.

In preparing the spray-dried base sorbent material, a metal promoter component, such as elemental metal, metal oxide, and/or metal-containing compounds, preferably nickel nitrate, can be added to the spray-dried base sorbent material as a component(s) of the original mixture, or they can be added after the original mixture has been spray dried and calcined. If a metal promoter component is added to the spray-dried base sorbent material after it has been spray-dried and calcined, the spray-dried base sorbent material should be dried and calcined a second time. The spray-dried base sorbent material is preferably dried a second time at a temperature generally in the range of from about 100° F. to about 650° F. Preferably, the spray-dried base sorbent material can be dried a second time at a temperature generally in the range of from about 150° F. to about 600° F. and, more preferably, in the range of from 200° F. to 550° F. The time period for conducting the drying a second time is generally in the range of from about 0.5 hour to about 8 hours, preferably in the range of from about 1 hour to about 6 hours and, more preferably, in the range of from 1.5 hours to 4 hours. Such drying a second time is generally carried out at a pressure in the range of from about atmospheric (i.e., about 14.7 pounds per square inch absolute) to about 100 pounds per square inch absolute (psia), preferably about atmospheric.

This spray-dried base sorbent material is then calcined, preferably in an oxidizing atmosphere such as in the presence of oxygen or air, under a calcining condition. Such calcining condition includes a temperature suitable for achieving the desired degree of calcination, for example, generally in the range of from about 700° F. to about 1600° F., preferably, in the range of from about 800° F. to about 1500° F., and, more preferably, in the range of from 900° F. to 1400° F. Such calcining condition includes a period of time suitable for achieving the desired degree of calcination, for example, generally in the range of from about 0.5 hour to about 6 hours, preferably, in the range of from about 1 hour to about 5 hours and, more preferably, in the range of from 1.5 hours to 4 hours, until volatile matter is removed and until at least a portion of the elemental metal and/or the metal-containing compounds is converted to a metal oxide. Such calcining condition includes a pressure generally in the range of from about 7 pounds per square inch absolute (psia) to about 750 psia, preferably in the range of from about 7 psia to about 450 psia, and, more preferably, in the range of from 7 psia to 150 psia.

Adding the metal promoter component, such as elemental metal, metal oxide, and/or metal-containing compounds, preferably nickel nitrate, to the base sorbent material as described hereinabove can be conducted before, after, or both before and after, such base sorbent material is coated with an attrition-resistant coating according to the inventive process(es) disclosed herein.

The base sorbent material, preferably agglomerated base sorbent material or spray-dried base sorbent material, having a mean particle size as disclosed hereinabove, is then coated or encapsulated with a coating comprising a silicate component to thereby provide a sorbent composition having an attrition-resistant coating comprising a silicate component and having an enhanced attrition resistance compared to a sorbent which does not have such attrition-resistant coating. The term “silicate component” refers to any of the widely occurring compounds comprising silicon and oxygen with or without hydrogen. Examples of a silicate component include, but are not limited to, a silicate, a metal silicate, an ammonium silicate, an organosilicate, a silica sol, a colloidal silica, and the like and combinations thereof. Preferably, a silicate component is a silica sol. More preferably, a silicate component is a metal silicate.

Coating of the base sorbent material with a silicate component can be performed by any suitable method(s) or means known in the art which will provide for a sorbent composition having an attrition-resistant coating comprising a silicate component. Generally, the attrition-resistant coating will cover in the range of from about 10 percent of the surface area of the base sorbent material to about 100 percent of the surface area of the base sorbent material. Preferably, the attrition-resistant coating will cover in the range of from about 50 percent of the surface area of the base sorbent material to about 100 percent of the surface area of the base sorbent material, more preferably, in the range of from about 75 percent of the surface area of the base sorbent material to about 100 percent of the surface area of the base sorbent material and, most preferably, in the range of from 85 percent of the surface area of the base sorbent material to 100 percent of the surface area of the base sorbent material.

Suitable methods of coating the base sorbent material with a silicate component can include, but are not limited to, impregnating techniques such as standard incipient wetness impregnation (i.e., essentially completely filling the pores of a substrate material with a solution of the incorporating elements), spray impregnation techniques, wet impregnation, spray drying, chemical vapor deposition, plasma spray deposition, and the like. It is preferred, however, to use a spray impregnation technique whereby the base sorbent material is contacted with a fine spray of a solution containing a silicate component wherein the solution has the desired amount of a silicate component dissolved in a sufficient volume of an aqueous medium, such as water, to fill the total pore volume of the base sorbent material or, in other words, to effect an incipient wetness impregnation of the base sorbent material. For example, spraying of an aqueous solution containing a silicate component onto the base sorbent material can be conducted using a sonic nozzle to atomize the aqueous solution which can then be sprayed onto the base sorbent material while such base sorbent material is rotated on a disk or being tumbled in a tumbler.

If the silicate component comprises a metal silicate, the metal of the metal silicate is preferably a metal selected from the group consisting of Groups I and II of the Periodic Table of the Elements and the like and combinations thereof. The metal of the metal silicate is more preferably a metal selected from the group consisting of sodium, potassium, and the like and combinations thereof. Thus, a preferred coating is selected from the group consisting of sodium silicate, potassium silicate, and the like and combinations thereof. More preferably, the metal of the metal silicate is sodium. Thus, a more preferred coating comprises sodium silicate.

If the silicate component comprises an organosilicate, such organosilicate can be selected from the group consisting of compounds comprising silica, oxygen, and carbon-containing components. The presently preferred organosilicate is a tetra alkyl orthosilicate. Examples of a tetra alkyl orthosilicate include, but are not limited to, tetra methyl orthosilicate, tetra ethyl orthosilicate, tetra propyl orthosilicate, and the like and combinations thereof. Preferably, such tetra alkyl orthosilicate is tetra ethyl orthosilicate (“TEOS”).

If the silicate component comprises a silica sol or a colloidal silica, any method(s) or manner known in the art can be used to prepare such silica sol or colloidal silica. A particularly suitable method of preparing a silica sol is by blending sodium silicate and an acid in a high shear mixer. Any mineral acid, for example, sulfuric acid, nitric acid, phosphoric acid, hydrochloric acid, and the like, or a carboxylic acid such as acetic acid, may be used. Mixtures of these acids may also be used.

Generally, any suitable quantity of solution containing a silicate component can be used to impregnate the base sorbent material. Preferably, the quantity of solution (containing a silicate component) used will provide for a sorbent composition having a silicate concentration in the range of from about 1 weight percent based on the total weight of the sorbent composition to about 40 weight percent. More preferably, the quantity of silicate solution used will be such as to provide a sorbent composition having a silicate concentration in the range of from about 5 weight percent based on the total weight of the sorbent composition to about 30 weight percent and, most preferably, in the range of from 10 weight percent based on the total weight of the sorbent composition to about 20 weight percent.

In preparing the sorbent composition, the impregnation solution is any solution and amount of such solution which suitably provides for an impregnation of a base sorbent material to provide a sorbent composition having a silicate concentration as described hereinabove. If the impregnation solution is an aqueous solution, the aqueous solution can include a silicate component that is soluble in an aqueous medium such as water. The concentration of the silicate component in the solution can generally be in the range of from about 0.1 gram of silicate component per gram of solution to about 10 grams of silicate component per gram of solution. Preferably, the concentration of the silicate component in the solution can be in the range of from about 0.1 gram of silicate component per gram of solution to about 5 grams of silicate component per gram of solution and, more preferably, the concentration of the silicate component in the solution can be in the range of from 0.1 gram of silicate component per gram of solution to 2 grams of silicate component per gram of solution. Generally, the weight ratio of silicate component to solution can be in the range of from about 0.25:1 to about 2:1, preferably, in the range of from about 0.5:1 to about 1.5:1 and, more preferably, in the range of from 0.75:1 to 1.25:1.

The sorbent composition having an attrition-resistant coating comprising a silicate component is preferably dried under a drying condition and then calcined under a calcining condition. Such drying condition includes a temperature generally in the range of from about 100° F. to about 650° F., preferably, in the range of from about 150° F. to about 600° F. and, more preferably, in the range of from 200° F. to 550° F. Such drying condition includes a time period for conducting the drying generally in the range of from about 0.5 hour to about 8 hours, preferably in the range of from about 1 hour to about 6 hours and, more preferably, in the range of from 1.5 hours to 4 hours. Such drying condition includes a pressure generally in the range of from about atmospheric (i.e., about 14.7 pounds per square inch absolute) to about 100 pounds per square inch absolute (psia), preferably about atmospheric.

The dried sorbent composition can also be calcined, preferably in an oxidizing atmosphere such as in the presence of oxygen or air, under a calcining condition suitable for achieving the desired degree of calcination and to thereby provide a dried and calcined sorbent composition having an attrition-resistant coating comprising a silicate component. Such calcining condition includes a temperature generally in the range of from about 700° F. to about 1600° F., preferably, in the range of from about 800° F. to about 1500° F. and, more preferably, in the range of from 900° F. to 1400° F. Such calcining condition incudes a period of time suitable for achieving the desired degree of calcination, for example, generally in the range of from about 0.5 hour to about 6 hours, preferably, in the range of from about 1 hour to about 5 hours and, more preferably, in the range of from 1.5 hours to 4 hours. Such calcining condition also includes a pressure generally in the range of from about 7 pounds per square inch absolute (psia) to about 750 psia, preferably in the range of from about 7 psia to about 450 psia, and, more preferably, in the range of from 7 psia to 150 psia.

The sorbent composition has a mean particle size generally in the range of from about 1 micrometer to about 10 millimeters. Preferably, the sorbent composition has a mean particle size in the range of from about 10 micrometers to about 1000 micrometers. More preferably, the sorbent composition can have a mean particle size in the range of from about 20 micrometers to about 500 micrometers and, most preferably, the mean particle size can be in the range of from 30 micrometers to 400 micrometers. The term “mean particle size” has been defined hereinabove.

The attrition resistance of the sorbent composition is measured as the Davison Index. The term “Davison Index” (“DI”) refers to a measure of a sorbent's resistance to particle size reduction under controlled conditions of turbulent motion. The Davison Index represents the weight percent of the over 20 micrometer particle size fraction which is reduced to particle sizes of less than 20 micrometers under test conditions. The Davison Index is measured using a Jet cup attrition determination method. The Jet cup attrition determination method involves screening a 5 gram sample of sorbent to remove particles in the 0 to 20 micrometer size range. The particles above 20 micrometers are then subjected to a tangential jet of air at a rate of 21 liters per minute introduced through a 0.0625 inch orifice fixed at the bottom of a specially designed Jet cup (1″ I.D.×2″ height) for a period of 1 hour. The Davison Index (“DI”) is calculated as follows:

$$DI = \frac{Weight of 0 to 20 micrometer material formed during test}{Weight of original 20 + micrometer fraction being tested} \times 100$$

The sorbent composition having an attrition-resistant coating comprising a silicate component has a Davison Index generally less than about 35 percent. Preferably, the sorbent composition has a Davison Index in the range of from about 1 percent to about 30 percent. More preferably, the sorbent composition has a Davison Index in the range of from 5 percent to 25 percent.

The sorbent composition having an attrition-resistant coating comprising a silicate component has an enhanced attrition resistance when compared to sorbent compositions which do not have such attrition-resistant coating comprising a silicate component.

The process of the present invention is a sorption process for removing sulfur compounds from a sulfur-containing fluid stream containing therein such sulfur compounds, which particularly include hydrogen sulfide. A sulfur-containing fluid stream containing hydrogen sulfide is contacted with the sorbent composition of the present invention under suitable sorption conditions to substantially reduce the concentration of hydrogen sulfide of the sulfur-containing fluid stream without significantly increasing the concentration of sulfur dioxide therein. The term “fluid” refers to a gas, liquid, vapor, or combinations thereof.

It is believed that the hydrogen sulfide is being absorbed by the sorbent composition and thus the term “sorption”, or like term in any form, is utilized for the sake of convenience. However, the exact chemical phenomenon occurring is not the inventive feature of the process of the present invention and the use of the term “sorption”, or like term in any form, is not intended to limit the present invention.

The chemical changes that are believed to occur in the sorption composition during this cyclic process are summarized in the following equations:

ZnO+H₂→S ZnS+H₂O (I)

ZnS+Oxygen→ZnO+SOₓ (II)

The sorption composition of the present invention may be utilized to remove hydrogen sulfide from any suitable sulfur-containing fluid stream. The hydrogen sulfide may be produced by the hydrodesulfurization of organic sulfur compounds or may be originally present in the sulfur-containing fluid stream as hydrogen sulfide. Examples of suitable sulfur-containing fluid streams include, but are not limited to, light hydrocarbons such as methane, ethane and natural gas; gases and liquids derived from petroleum products; products from extraction and/or liquefaction of coal and lignite; gases and liquids derived from tar sands and shale oil; coal derived synthesis gas; gases such as hydrogen and nitrogen; gaseous oxides of carbon; steam and the inert gases such as helium and argon.

One embodiment of the inventive sorption process comprises contacting a sulfur-containing fluid stream containing a concentration of hydrogen sulfide with a fluidized bed of the sorption composition described herein and contained within a fluidization zone. The fluidization zone can be defined by any apparatus or equipment which can suitably define such fluidization zone including, for example, a vessel. The contacting sulfur-containing fluid stream, preferably in the form of a gaseous stream, serves as the lifting gas to provide for fluidization. The lift gas will flow upwardly through the bed of sorbent composition at a rate such that the frictional resistance equals the weight of the bed. The velocity of the lift gas or fluidization gas should be sufficient to provide for the required fluidization of the sorbent composition, but, generally can range from about 0.1 ft/sec to about 80 ft/sec. Preferably, the velocity of the fluidization gas through the fluidization zone can range from about 0.15 ft/sec to about 50 ft/sec and, more preferably, the velocity of the fluidization gas can range from 0.175 ft/sec to 40 ft/sec.

The process conditions within the fluidization zone are such that a portion, preferably a substantial portion, of the hydrogen sulfide concentration in the sulfur-containing fluid stream is reduced by the sorption mechanism or the removal of the hydrogen sulfide from the sulfur-containing fluid stream by the sorbent composition. Such suitable sorption process conditions include a temperature in the range of from about 300° F. to about 2000° F., preferably, in the range of from about 500° F. to about 1800° F. and, more preferably, in the range of from 600° F. to 1700° F.

Any suitable pressure can be utilized for the process(es) of the present invention. The pressure of the sulfur-containing fluid stream being treated is not believed to have an important effect on the absorption process of the present invention and will generally be in the range of from about atmospheric to about 2000 pounds per square inch gauge (psig) during the treatment.

The hydrogen sulfide concentration of the sulfur-containing fluid stream to be treated will generally be in the range of from about 100 parts hydrogen sulfide per million parts by volume of sulfur-containing fluid stream (i.e., 100 ppmv) upwardly to about 20,000 ppmv. Preferably, the hydrogen sulfide concentration of the sulfur-containing fluid stream can be in the range of from about 200 ppmv to about 10,000 ppmv and, more preferably, in the range of from 300 ppmv to 5,000 ppmv.

The treated stream exiting the fluidization zone shall have a concentration of hydrogen sulfide below that of the sulfur-containing fluid stream entering the fluidization zone. Thus, the concentration of hydrogen sulfide in the treated stream can be less than about 100 parts hydrogen sulfide per million parts by volume of treated stream (i.e., 100 ppmv). Preferably, the concentration of hydrogen sulfide in the treated stream is in the range of from about 0 ppmv to about 100 ppmv, more preferably the concentration of hydrogen sulfide in the treated stream is in the range of from about 0 ppmv to about 50 ppmv and, most preferably, the concentration of hydrogen sulfide in the treated stream is in the range of from 0 ppmv to 30 ppmv.

If it is desired to regenerate the sorbent composition of this invention after prolonged use in the sorption process(es) described herein, the regeneration can be accomplished by calcining the sorhent composition according to any method(s) or means known in the art such as, for example, calcining in an oxidizing atmosphere such as in air at a temperature that does not exceed about 1500° F. to bum off sulfur-containing deposits.

The sorbent composition of this invention can be used in sulfur removal processes where there is achieved a contacting of the sorbent composition with a sulfur-containing fluid stream, and thereafter, of the sorbent composition with oxygen or an oxygen-containing gas which is utilized to regenerate the sorbent composition. The sulfur removal process is in no way limited to the use of a particular apparatus. Examples of such sulfur removal processes are disclosed in U.S. Pat. Nos. 4,990,318; 5,077,261; 5,102,854; 5,108,975; 5,130,288; 5,174,919; 5,177,050; 5,219,542; 5,244,641; 5,248,481; and 5,281,445.

The following examples are presented to further illustrate this invention and are not to be construed as unduly limiting the scope of this invention.

### EXAMPLE I

Sorbent A (Control) was a spray-dried base sorbent material prepared in the following manner. A 20 gram quantity of sodium pyrophosphate was dissolved in 2224 grams of distilled water to provide a solution. To the solution was added 200 grams of Vista DISPAL 180 alumina with vigorous stirring. While the alumina slurry was being mixed with a high shear mixer, a 628 gram quantity of CELITE Filter Cel (Celite Corporation, Lompoc, Calif.) and a 788 gram quantity of zinc oxide were added to the slurry and further mixed for 20 minutes. The resulting thick slurry was sieved through a 25 mesh screen and spray dried using a Niro Mobile Minor Spray Dryer supplied by Niro Inc., Columbia, Md., to obtain a spray-dried micro spherical product. The operating conditions of the Niro Mobile Minor Spray Dryer included: Inlet Temperature=608° F., Outlet Temperature=212° F., Slurry Feed Rate 50 to 80 mL/min, and Atomizing Air=60 to 90 L/min. Such spray-dried micro spherical product was dried at 302° F. for 3 hours and then calcined at 1175° F. for 1 hour. A 100 gram quantity of the thus dried and calcined spray-dried micro spherical product was then impregnated with a solution of 59.42 grams of nickel nitrate (Ni(NO₃)₂.6H₂O) and 62.9 grams of distilled water. The thus-impregnated material was then dried at 302° F. for 3 hours and then calcined at 1175° F. for 1 hour to thereby provide a spray-dried base sorbent material (Sorbent A).

Sorbent B (Invention) was prepared by heating a 550 gram quantity of the above-described spray-dried base sorbent material (Sorbent A) in air at a temperature of about 225° F. for about 30 minutes. The thus-heated spray-dried base sorbent material was then impregnated with a solution of 220 mL (i.e., 305 grams) of sodium silicate solution, obtained from Aldrich Chemical Company, Milwaukee, Wis. containing approximately 14% NaOH and approximately 27% SiO₂ and having a density of 1.390, which was diluted with 65 mL of distilled water. To impregnate, the solution of sodium silicate and water was sprayed onto the spray-dried base sorbent material with an Ultrasonic Atomizer (the frequency was set at 20 to 120 kHz) supplied by Sono-Tek Corporation, Milton, N.Y., while the spray-dried base sorbent material was rotated in a 4 liter plastic beaker. The thus-coated spray-dried base sorbent material was then dried at about 250° F. for about 1.5 hours. In order to maintain the solution of sodium silicate and water as a liquid, the impregnation was done at less than 100° C. the base sorbent material also was less than 100° C. at the time of impregnation. The thus-coated spray-dried base sorbent material was then calcined in air at about 1000° F. for about 1.25 hours to thereby provide about 662 grams of sorbent composition (Sorbent B) having a bulk density of 0.97.

The physical and chemical characteristics of Sorbents A and B are included in Table I. The attrition resistance of the sorbents is referred to in Table I below as the “Davison Index” (“DI”). The Davison Index, as described hereinabove, is a measure of a sorbent's resistance to particle size reduction under controlled conditions of turbulent motion. The Davison Index represents the weight percent of the over 20 micrometer particle size fraction which is reduced to particle sizes of less than 20 micrometers under test conditions. The Davison Index was measured using a Jet cup attrition determination method. The Jet cup attrition determination method involved screening a 5 gram sample of sorbent to remove particles in the 0 to 20 micrometer size range. The particles above 20 micrometers were then subjected to a tangential jet of air at a rate of 21 liters per minute introduced through a 0.0625 inch orifice fixed at the bottom of a specially designed Jet cup (1″ I.D.×2″ height) for a period of 1 hour. The Davison Index (“DI”) was calculated as follows:

$$DI = \frac{Weight of 0 to 20 micrometer material formed during test}{Weight of original 20 + micrometer fraction being tested} \times 100$$

TABLE I
Sorbent Properties

| Particle Size Distribution | Sorbent A (Control) | Sorbent B (Invention) |
|---|---|---|
| (%) | (No Coating) | (Coating) |
| >297 microns | 5.6 | 8.0 |
| 149 microns | 76.9 | 78.8 |
| 105 microns | 12.4 | 9.6 |
| 88 microns | 2.7 | 2.0 |
| 74 microns | 1.3 | 1.0 |
| 53 microns | 0.9 | 0.5 |
| <53 microns | 0.1 | 0.1 |
| Bulk Density (g/cc) | 0.78 | 0.97 |
| Davison Index | 100 | 23 |

### EXAMPLE II

To test the efficacy of the fluidizable sorbents, Sorbent A (Control) and Sorbent B (Invention) were subjected to a standard sorption test. The sorption test was carried out in a unit comprising a 20 mm O.D. quartz reactor and a 2 mm thermocouple well. The reactor was operated in a fluid bed up flow mode using 10 grams of the tested sorbent. The sorbent was heated to 900° F. in a stream of nitrogen. When the desired temperature was obtained, the nitrogen stream was replaced with a stream of simulated sulfur plant feed gas comprising 4.2 volume percent hydrogen sulfide, 40.0 volume percent carbon dioxide and 55.8 volume percent nitrogen. The gas hourly space velocity was 2880 cc feed/gram sorbent/hour. Sulfur loading was monitored by measuring the concentration of hydrogen sulfide in the reactor effluent using a General Monitors hydrogen sulfide monitor suited to the concentration ranges encountered. Once the sorbent was fully loaded, as evidenced by hydrogen sulfide breakthrough, the flow of the simulated sulfur plant gas to the reactor was halted and the reactor was purged with nitrogen for 45 minutes while it was heated to a regeneration temperature of 1100° F. The loaded sorbent was regenerated in a stream of air at 240 cc/minute for about 5 hours. Then the reactor was purged with nitrogen for about 40 minutes as it was cooled to 900° F. Then, the nitrogen flow was halted and the flow of simulated sulfur plant feed gas was resumed to begin another absorption cycle. The process was repeated for the desired number of cycles. The results of the test are shown below in Table II.

TABLE II
Hydrogen Sulfide Sorption Test Results

Sulfur Loading (%)*

| | Sorbent A (Control) | Sorbent B (Invention) |
|---|---|---|
| Cycle # | (No Coating) | (Coating) |
| 1 | 12.5 | 3.4 |
| 2 | 12.4 | 4.7 |
| 3 | 14.1 | 7.8 |
| 4 | 14.8 | 10.1 |
| 5 | 15.1 | 12.0 |
| 6 | 12.7 | 12.4 |
| 7 | — | 13.4 |
| 8 | — | 14.1 |
| 9 | — | 14.2 |
| 10 | — | — |
| 11 | — | 13.6 |
| 12 | — | 13.9 |

*The weight percent sulfur in sorbent at hydrogen sulfide breakthrough

Test data in Table II clearly show that after the initial 2 to 3 cycles of operation Invention Sorbent B, which had an attrition-resistant coating, exhibited a very high capacity to remove sulfur which was comparable to Control Sorbent A without an attrition-resistant coating, yet Invention Sorbent B exhibited superior attrition resistance properties. Invention Sorbent B exhibited excellent sulfur removal performance and little or no loss in sulfur loading capacity during the 12 cycles of operation conducted in Example II. The improvement in sorbent attrition resistance is believed to be due to the novel process of making the inventive sorbent composition by a process of coating a base sorbent material, such as a spray-dried base sorbent material, with a novel attrition-resistant coating to produce a sorbent composition with enhanced attrition resistance compared to a sorbent composition which does not have such attrition-resistant coating.

The difference in performance between Invention Sorbent B and Control Sorbent A is certainly unexpected. One would not expect that coating a base sorbent material, such as a spray-dried base sorbent material, with an attrition-resistant coating to produce a sorbent composition would enhance the performance of such sorbent composition in terms of attrition resistance, yet, at comparable sulfur loadings. The results demonstrate that the inventive sorbent composition in which a base sorbent material is coated with an attrition-resistant coating gives a sorbent composition that is significantly superior to a sorbent which does not have such attrition-resistant coating.

The data also clearly show that Invention Sorbent B was highly effective in sulfur removal. Even after 12 cycles of operation, the amount of sulfur removed at breakthrough was quite high.

The results shown in the above examples clearly demonstrate that the present invention is well adapted to carry out the objects and attain the ends and advantages mentioned as well as those inherent therein.

Reasonable variations, modifications, and adaptations can be made within the scope of this disclosure and the appended claims without departing from the scope of this invention.

What is claimed is:

1. A process of making a sorbent composition comprising coating a base sorbent material with an attrition-resistant coating comprising a silicate component wherein said attrition-resistant coating covers in the range of from about 10 percent of the surface area of said base sorbent material to about 100 percent of the surface area of said base sorbent material and further wherein said base sorbent material has a temperature less than about 100° C. during said coating.

2. A process according to claim 1 wherein said silicate component is selected from the group consisting of silicate, metal silicate, ammonium silicate, organosilicate, silica sol, colloidal silica, and combinations thereof.

3. A process according to claim 2 wherein a metal of said metal silicate is selected from the group consisting of Groups I and II of the Periodic Table of Elements.

4. A process according to claim 3 wherein said metal is selected from the group consisting of sodium, potassium, and combinations thereof.

5. A process according to claim 4 wherein said metal is sodium.

6. A process according to claim 5 wherein said organosilicate is selected from the group consisting of compounds comprising silica, oxygen, and carbon-containing components.

7. A process according to claim 6 wherein said organosilicate comprises a tetra alkyl orthosilicate selected from the group consisting of tetra methyl orthosilicate, tetra ethyl orthosilicate, tetra propyl orthosilicate, and combinations thereof.

8. A process according to claim 7 wherein said tetra alkyl orthosilicate is tetra ethyl orthosilicate.

9. A process according to claim 8 wherein said silicate component is sodium silicate.

10. A process according to claim 8 wherein said silicate component is silica sol.

11. A process according to claim 1 wherein said coating comprises impregnating said base sorbent material with a solution comprising said silicate component wherein the quantity of said solution provides for said sorbent composition having a silicate concentration in the range of from about 1 weight percent based on the total weight of said sorbent composition to about 40 weight percent of said sorbent composition.

12. A process according to claim 11 wherein said solution has a concentration of silicate component in the range of from about 0.1 gram of silicate component per gram of solution to about 10 grams of silicate component per gram of solution.

13. A process according to claim 12 wherein said solution further comprises an aqueous medium.

14. A process according to claim 13 wherein said aqueous medium is water.

15. A process according to claim 14 wherein said impregnating comprises a spray impregnation technique and further wherein said spray impregnation technique comprises contacting said base sorbent material with a fine spray of said solution.

16. A process according to claim 15 further comprising drying said sorbent composition under a drying condition and further wherein said drying condition comprises:
a temperature in the range of from about 100° F. to about 650° F.,
a time period in the range of from about 0.5 hour to about 8 hours, and
a pressure in the range of from about atmospheric to about 100 pounds per square inch absolute.

17. A process according to claim 16 further comprising calcining said sorbent composition under a calcining condition wherein said calcining condition comprises:
a temperature in the range of from about 700° F. to about 1600° F.,
a time period in the range of from about 0.5 hour to about 6 hours, and
a pressure in the range of from about 7 pounds per square inch absolute (psia) to about 750 psia.

18. A process according to claim 17 wherein said sorbent composition has a Davison Index less than about 35 percent.

19. A process according to claim 18 wherein said sorbent composition has a mean particle size in the range of from about 1 micrometer to about 10 millimeters.

20. A process according to claim 19 wherein said base sorbent material comprises a zinc component selected from the group consisting of zinc oxide, zinc sulfide, zinc sulfate, zinc hydroxide, zinc carbonate, zinc acetate, zinc nitrate, zinc chloride, zinc bromide, zinc iodide, zinc oxychloride, zinc stearate, and combinations thereof.

21. A process according to claim 20 wherein the amount of said zinc component in said base sorbent material is in the range of from about 5 weight percent based on the total weight of said base sorbent material to about 75 weight percent.

22. A process according to claim 21 wherein said base sorbent material further comprises: an alumina component in an amount in the range of from about 1 weight percent based on the total weight of said base sorbent material to about 50 weight percent; a silica component in an amount in the range of from about 5 weight percent based on the total weight of said base sorbent material to about 85 weight percent; and a metal promoter component in an amount in the range of from about 0.01 weight percent based on the total weight of said base sorbent material to about 60 weight percent.

23. A process according to claim 22 wherein said base sorbent material has a mean particle size in the range of from about 1 micrometer to about 10 millimeters.

24. A process according to claim 23 wherein said base sorbent material is an agglomerated base sorbent material.

25. A process according to claim 24 wherein said base sorbent material is a spray-dried base sorbent material.

26. A process according to claim 24 wherein said agglomerated base sorbent material is made by a process comprising:
mixing said zinc component, said alumina component, and said silica component to form a mixture;
impregnating said mixture with an aqueous solution comprising said metal promoter component to form an impregnated mixture;
agglomerating said impregnated mixture to form an agglomerate; and
granulating said agglomerate to produce a granulated material.

27. A process according to claim 24 wherein said agglomerated base sorbent material is prepared by the steps comprising:
forming an agglomerate comprising said zinc component, said alumina component, and said silica component;
impregnating said agglomerate with an aqueous solution comprising said metal promoter component to form an impregnated mixture; and
granulating said impregnated mixture to produce a granulated material.

28. A process according to claim 24 wherein said agglomerated base sorbent material is prepared by the steps comprising:
forming an agglomerate comprising said zinc component, said alumina component, and said silica component;
granulating said agglomerate to produce a granulated material; and
impregnating said agglomerate with an aqueous solution comprising said metal promoter component to form an impregnated mixture.

29. A process according to claim 26 further comprising: prior to the granulating step, drying said agglomerate under a drying condition wherein said drying condition comprises a temperature in the range of from about 100° F. to about 650° F., a time period in the range of from about 0.5 hour to about 8 hours, and a pressure in the range of from about atmospheric to about 100 psia; followed by calcining under a calcining condition wherein said calcining condition comprises: a temperature in the range of from about 700° F. to about 1600° F., a time period in the range of from about 0.5 hour to about 6 hours, and a pressure in the range of from about 7 psia to about 750 psia; and further wherein said aqueous solution has a concentration of said metal promoter component in the range of from about 0.1 gram of said metal promoter component per gram of aqueous solution to about 5 grams of said metal promoter component per gram of aqueous solution.

30. A process according to claim 27 further comprising: prior to the impregnating step, drying said agglomerate under a drying condition wherein said drying condition comprises a temperature in the range of from about 100° F. to about 650° F., a time period in the range of from about 0.5 hour to about 8 hours, and a pressure in the range of from about atmospheric to about 100 psia; followed by calcining under a calcining condition wherein said calcining condition comprises: a temperature in the range of from about 700° F. to about 1600° F., a time period in the range of from about 0.5 hour to about 6 hours, and a pressure in the range of from about 7 psia to about 750 psia; and further wherein said aqueous solution has a concentration of said metal promoter component in the range of from about 0.1 gram of said metal promoter component per gram of aqueous solution to about 5 grams of said metal promoter component per gram of aqueous solution.

31. A process according to claim 28 further comprising: prior to the granulating step, drying said agglomerate under a drying condition wherein said drying condition comprises a temperature in the range of from about 100° F. to about 650° F., a time period in the range of from about 0.5 hour to about 8 hours, and a pressure in the range of from about atmospheric to about 100 psia; followed by calcining under a calcining condition wherein said calcining condition comprises: a temperature in the range of from about 700° F. to about 1600° F., a time period in the range of from about 0.5 hour to about 6 hours, and a pressure in the range of from about 7 psia to about 750 psia; and further wherein said aqueous solution has a concentration of said metal promoter component in the range of from about 0.1 gram of said metal promoter component per gram of aqueous solution to about 5 grams of said metal promoter component per gram of aqueous solution.

32. A process according to claim 25 wherein said spray-dried base sorbent material is made by a process comprising:
(a) contacting
(1) said zinc component,
(2) said alumina component,
(3) said silica component, and
(4) a dispersant component,
to form a mixture; and then
(b) spray drying said mixture to form said spray-dried base sorbent material.

33. A process according to claim 32 wherein said dispersant component is selected from the group consisting of condensed phosphates, sulfonated polymers and combinations thereof; and further wherein said spray-dried base sorbent material is contacted with said metal promoter component.

34. A process according to claim 33 wherein the amount of said dispersant component present in said spray-dried base sorbent material is in the range of from about 0.01 weight percent based on the total weight of said spray-dried base sorbent material to about 10 weight percent.

35. A process according to claim 22 wherein said base sorbent material further comprises a binder component and further wherein a metal of said metal promoter component is nickel.

36. A composition prepared by the process of claim 1.

37. A composition prepared by the process of claim 2.

38. A composition prepared by the process of claim 3.

39. A composition prepared by the process of claim 4.

40. A composition prepared by the process of claim 5.

41. A composition prepared by the process of claim 6.

42. A composition prepared by the process of claim 7.

43. A composition prepared by the process of claim 8.

44. A composition prepared by the process of claim 9.

45. A composition prepared by the process of claim 10.

46. A composition prepared by the process of claim 11.

47. A composition prepared by the process of claim 12.

48. A composition prepared by the process of claim 13.

49. A composition prepared by the process of claim 14.

50. A composition prepared by the process of claim 15.

51. A composition prepared by the process of claim 16.

52. A composition prepared by the process of claim 17.

53. A composition prepared by the process of claim 18.

54. A composition prepared by the process of claim 19.

55. A composition prepared by the process of claim 20.

56. A composition prepared by the process of claim 21.

57. A composition prepared by the process of claim 22.

58. A composition prepared by the process of claim 23.

59. A composition prepared by the process of claim 24.

60. A composition prepared by the process of claim 25.

61. A composition prepared by the process of claim 26.

62. A composition prepared by the process of claim 27.

63. A composition prepared by the process of claim 28.

64. A composition prepared by the process of claim 29.

65. A composition prepared by the process of claim 30.

66. A composition prepared by the process of claim 31.

67. A composition prepared by the process of claim 32.

68. A composition prepared by the process of claim 33.

69. A composition prepared by the process of claim 34.

70. A composition prepared by the process of claim 35.

71. A sorbent composition comprising a base sorbent material having an attrition-resistant coating comprising a silicate component wherein said attrition-resistant coating covers in the range of from about 10 percent of the surface area of said base sorbent material to about 100 percent of the surface area of said base sorbent material.

72. A sorbent composition according to claim 71 wherein said silicate component is selected from the group consisting of silicate, metal silicate, ammonium silicate, organosilicate, silica sol, colloidal silica, and combinations thereof.

73. A sorbent composition according to claim 72 wherein a metal of said metal silicate is selected from the group consisting of Groups I and II of the Periodic Table of Elements.

74. A sorbent composition according to claim 73 wherein said metal is selected from the group consisting of sodium, potassium, and combinations thereof.

75. A sorbent composition according to claim 74 wherein said metal is sodium.

76. A sorbent composition according to claim 75 wherein said organosilicate is selected from the group consisting of compounds comprising silica, oxygen, and carbon-containing components.

77. A sorbent composition according to claim 76 wherein said organosilicate comprises a tetra alkyl orthosilicate selected from the group consisting of tetra methyl orthosilicate, tetra ethyl orthosilicate, tetra propyl orthosilicate, and combinations thereof.

78. A sorbent composition according to claim 77 wherein said tetra alkyl orthosilicate is tetra ethyl orthosilicate.

79. A sorbent composition according to claim 78 wherein said silicate component is sodium silicate.

80. A sorbent composition according to claim 78 wherein said silicate component is silica sol.

81. A sorbent composition according to claim 79 wherein said sorbent composition has a silicate concentration in the range of from about 1 weight percent based on the total weight of said sorbent composition to about 40 weight percent of said sorbent composition.

82. A sorbent composition according to claim 81 wherein said sorbent composition has been dried under a drying condition and further wherein said drying condition comprises:
a temperature in the range of from about 100° F. to about 650° F.,
a time period in the range of from about 0.5 hour to about 8 hours, and
a pressure in the range of from about atmospheric to about 100 pounds per square inch absolute.

83. A sorbent composition according to claim 82 wherein said sorbent composition has been calcined under a calcining condition and further wherein said calcining condition comprises:
a temperature in the range of from about 700° F. to about 1600° F.,
a time period in the range of from about 0.5 hour to about 6 hours, and
a pressure in the range of from about 7 pounds per square inch absolute (psia) to about 750 psia.

84. A sorbent composition according to claim 83 wherein said sorbent composition has a Davison Index less than about 35 percent.

85. A sorbent composition according to claim 84 wherein said sorbent composition has a mean particle size in the range of from about 1 micrometer to about 10 millimeters.

86. A sorbent composition according to claim 85 wherein said base sorbent material comprises a zinc component selected from the group consisting of zinc oxide, zinc sulfide, zinc sulfate, zinc hydroxide, zinc carbonate, zinc acetate, zinc nitrate, zinc chloride, zinc bromide, zinc iodide, zinc oxychloride, zinc stearate, and combinations thereof.

87. A sorbent composition according to claim 86 wherein the amount of said zinc component in said base sorbent material is in the range of from about 5 weight percent based on the total weight of said base sorbent material to about 75 weight percent.

88. A sorbent composition according to claim 87 wherein said base sorbent material further comprises an alumina component in an amount in the range of from about 1 weight percent based on the total weight of said base sorbent material to about 50 weight percent.

89. A sorbent composition according to claim 88 wherein said base sorbent material further comprises a silica component in an amount in the range of from about 5 weight percent based on the total weight of said base sorbent material to about 85 weight percent; and a metal promoter component in an amount in the range of from about 0.01 weight percent based on the total weight of said base sorbent material to about 60 weight percent.

90. A sorbent composition according to claim 89 wherein said base sorbent material is an agglomerated base sorbent material.

91. A sorbent composition according to claim 90 wherein said base sorbent material is a spray-dried base sorbent material.

92. A sorbent composition according to claim 91 wherein said spray-dried base sorbent material further comprises a dispersant component.

93. A sorbent composition according to claim 92 wherein said dispersant component is present in said spray-dried base sorbent material in an amount in the range of from about 0.01 weight percent based on the total weight of said spray-dried base sorbent material to about 10 weight percent.

94. A process for removing hydrogen sulfide from a sulfur-containing fluid stream, the steps comprising:
contacting said sulfur-containing fluid stream within a fluidization zone with a fluidized bed of a sorbent composition; and
recovering a stream having a concentration of hydrogen sulfide lower than that of said sulfur-containing fluid stream; and further wherein said sorbent composition is prepared by a process comprising coating a base sorbent material with an attrition-resistant coating comprising a silicate component.

95. A process according to claim 94 wherein the concentration of hydrogen sulfide in said sulfur-containing fluid stream is in the range of from about 100 ppmv upwardly to about 20,000 ppmv and the concentration of said hydrogen sulfide in said stream is less than about 100 ppmv.

96. A process according to claim 95 wherein the velocity of said sulfur-containing fluid stream in said fluidization zone is in the range of from about 0.1 ft/sec to about 80 ft/sec.

97. A process according to claim 96 wherein the contacting temperature is in the range of from about 300° F. to about 2000° F. and the contacting pressure is in the range of from about atmospheric to about 2000 psig.

98. A process for removing hydrogen sulfide from a sulfur-containing fluid stream, the steps comprising:
contacting said sulfur-containing fluid stream within a fluidization zone with a fluidized bed of a sorbent composition; and
recovering a stream having a concentration of hydrogen sulfide lower than that of said sulfur-containing fluid stream; and further wherein said sorbent composition comprises a base sorbent material having an attrition-resistant coating comprising a silicate component.

99. A process according to claim 98 wherein the concentration of hydrogen sulfide in said sulfur-containing fluid stream is in the range of from about 100 ppmv upwardly to about 20,000 ppmv and the concentration of hydrogen sulfide in said stream is less than about 100 ppmv.

100. A process according to claim 99 wherein the velocity of said sulfur-containing fluid stream in said fluidization zone is in the range of from about 0.1 ft/sec to about 80 ft/sec.

101. A process according to claim 100 wherein the contacting temperature is in the range of from about 300° F. to about 2000° F. and the contacting pressure is in the range of from about atmospheric to about 2000 psig.
